(19) United States
(12) Patent Application Publication
(10) Pub. No.: US 2008/0296061 A1
(43) Pub. Date: Dec. 4, 2008

(54) CONNECTOR FOR AN ELECTRICAL JUNCTION BOX

(76) Inventor: Jack Russell Kerr, JR., College Station, TX (US)

Correspondence Address: BLANK ROME LLP, ONE LOGAN SQUARE, PHILADELPHIA, PA, 19103, US

(21) Appl. No.: 12/130,427

(22) Filed: May 30, 2008

Related U.S. Application Data
(60) Provisional application No. 60/940,809, filed on May 30, 2007.

(51) Int. Cl. H02G 3/18

(52) U.S. Cl. 174/669

(57) ABSTRACT

This invention relates to a connector for securing a cable to an electrical junction box by contact with extending projections. In particular, the invention is a connector having a locking system for securing a cable in a knock-out opening of an electrical junction box.

### CROSS-REFERENCE TO RELATED APPLICATIONS

This application claims the benefit of U.S. Provisional Application Ser. No. 60/940,809 filed May 30, 2007, entitled, “Connector for an Electrical Junction Box”, which is incorporated herein by reference.

### FIELD OF THE INVENTION

This invention relates to a connector for connecting non-metallic sheathed cable to an electrical junction box. In particular, the invention is a connector for securing non-metallic sheathed cable in a knock-out opening of an electrical junction box.

### BACKGROUND OF THE INVENTION

Connectors for securely fastening non-metallic sheathed cable to an electrical junction box exist in various forms in the prior art. U.S. Pat. No. 5,693,910 to Gretz is a one-piece connector that has a C-shape that allows it to be easily inserted and locked into a knock-out opening in an electrical junction box. Gripping jaws located on the inside of the C-shaped one-piece connector apply tension to hold the non-metallic sheathed cable in place.

There is a need for an O-shaped one-piece connector that easily inserts into a standard size knock-out opening for an electrical junction box and is less expensive to manufacture. The presently disclosed connector for an electrical junction box satisfies these needs.

### BRIEF SUMMARY OF THE INVENTION

In a first embodiment, the invention is directed to a connector for an electrical junction box. The connector has a continuous flange and a cylindrical wall having a first end and a second end. The first end of the cylindrical wall is attached to the flange and at least one projecting tab extends therefrom. The connector is symmetrical about a midline.

In another embodiment, the invention is a connector for an electrical junction box having a continuous flange and a cylindrical wall. The cylindrical wall has a first end, a second end and a central portion. The first end of the cylindrical wall is attached to the flange. At least one projecting tab extends from the central portion proximate the first end of the cylindrical wall. The connector is designed to be symmetrical about a midline.

These embodiments will be explained in detail in the description herein.

### BRIEF DESCRIPTION OF THE DRAWINGS

FIG. 1 is a top-view of an exemplary embodiment of a connector for an electrical junction box of the present invention;

FIG. 2 is a bottom-view of the exemplary embodiment of the connector shown in FIG. 1;

FIG. 3 is a cross-sectional view taken through 3-3 of FIG. 2;

FIG. 4 is a cross-sectional view taken through 4-4 of FIG. 2;

FIG. 5 is a top-view of another exemplary embodiment of a connector for an electrical junction box of the present invention;

FIG. 6 is a bottom-view of the exemplary embodiment of the connector shown in FIG. 5;

FIG. 7 is a cross-sectional view taken through 7-7 of FIG. 6;

FIG. 8 is a cross-sectional view taken through 8-8 of FIG. 6; and

FIG. 9 is a cross-sectional view taken through 9-9 of FIG. 6.

### DESCRIPTION OF THE INVENTION

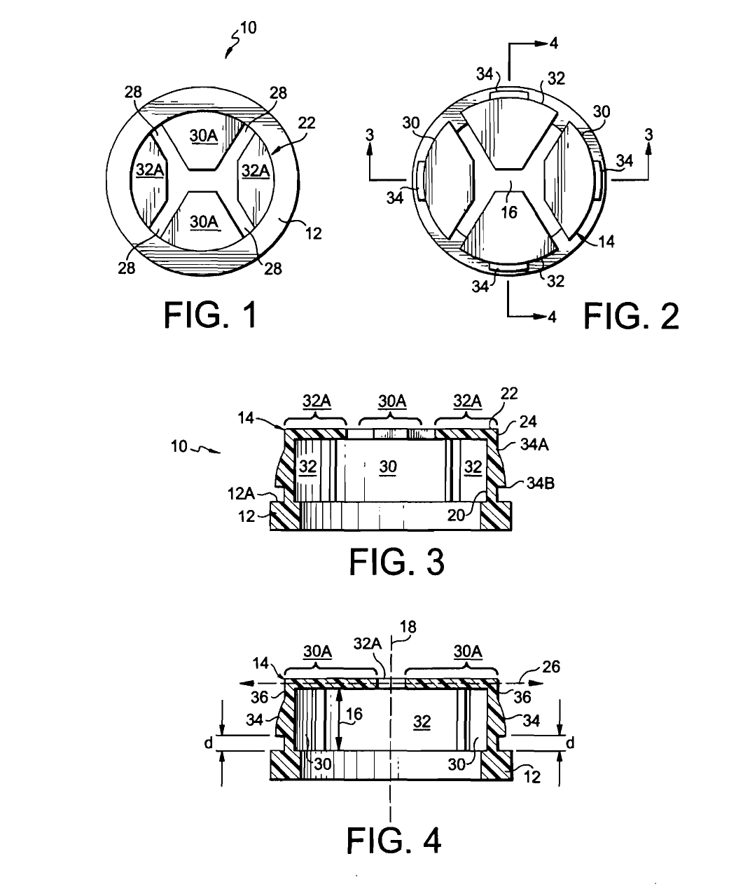

As shown in FIGS. 1-4, a first exemplary embodiment of the invention is a one-piece O-shaped connector 10 having a hollow body and fabricated from a flexible, resilient material, e.g. rubber or plastic. The connector 10 includes a flange 12 and a cylindrical wall 14. As best illustrated in FIGS. 3 and 4, the cylindrical wall 14 includes a hollow passageway 16 substantially parallel with its central axis 18. The flange 12 is located at a first end 20 of the cylindrical wall 14. A lower wall 22 of the cylindrical wall 14 is located at a second end 24, opposite the flange 12. A surface plane 26 of the lower wall 22 is substantially perpendicular to the central axis 18 of the cylindrical wall 14.

Cut-outs 28 extend on the cylindrical wall 14 from the flange 12 through the lower wall 22. The cutouts 28 form a first pair 30 and a second pair 32 of projecting gripping jaws in the cylindrical wall 14. Referring to FIG. 3, the cutouts 28 extend substantially parallel to the central axis 18 of the cylindrical wall 14 and contour the first and second pair of gripping jaws 30, 32 so as to be perpendicular to the central axis 18 on the tooth portions 30A, 32A of the first and second pair of gripping jaws 30, 32. The connection between the flange 12 and the cylindrical wall 14 functions as a hinge that allows the first pair 30 and second pair 32 of gripping jaws to flex and exert pressure toward the central axis 18 of the cylindrical wall 14 to hold a cable (not shown) inserted into the connector 10.

Referring to FIGS. 1 and 2, the cutouts 28 forming the first pair and second pair of projecting gripping jaws 30, 32 are such that the radial length of the tooth portion 30A of the first pair of gripping jaws 30 are greater than the radial length of the tooth portion 32A of the second pair 32 of gripping jaws. The cross-section of FIG. 3 illustrates the two “opposing” second pair of gripping jaws 32 having a shorter radial length tooth portion 32A, and one of the gripping jaws of the first pair of gripping jaws 30 having a longer radial length tooth portion 30A. The cross-section of FIG. 4 illustrates the two opposing first pair of gripping jaws 30 having a longer radial length tooth portion 30A, and one of the second pair of gripping jaws 32 having a shorter radial length tooth portion 32A. Having the tooth portions 30A, 32A of the first and second pair of gripping jaws 30, 32 of different lengths, allows increased tension on the cable traversing the connector from the longer tooth (in this embodiment 30A) of the gripping jaw pair. It is recognized by those skilled in the art that the radial length of each gripping jaw can be substantially equal. Further, the cutouts can form additional pairs of gripping jaws without departing from the core concept of the invention.

The symmetrical design of the connector 10, whether the first pair and second pair of gripping jaws 30, 32 are of equivalent length or not, allows proportional distribution of pressure on the cable traversing connector based on the O-shaped design. This distribution of the pressure from the gripping jaws takes on greater importance if the cable traversing the connector is not round. Variations of the pressure based on the design of the gripping jaws will ensure a snug fit regardless of the shape of the traversing cable. Further, the symmetrical design reduces costs in manufacture of the connector. Thus, the connector of the present invention is easy to install, reduces costs in manufacturing and allows variation based on the cable which will traverse the connector.

Referring to FIGS. 2-4, the cylindrical wall 14 of the connector 10 has an outer diameter appropriate to allow insertion into a standard size knock-out opening for an electrical junction box (not shown). The cylindrical wall 14 includes bumps 34, on an outer side wall 36 of each pair of gripping jaws 30, 32. The bumps 34 are an inclined plane or ramp that rises from the second end of the cylindrical wall 24, proximal the lower wall 22 to the first end of the cylindrical wall 20 proximal to the flange 12 as best illustrated in FIG. 3. It will be appreciated by those skilled in the art that the bump 34 could be a convex surface that rises from the lower wall end 22 of the cylindrical wall 14 to the flange end 12 of the cylindrical wall 14.

The outer diameter of the cylindrical wall 14 at the lower wall end of the bump 34A is appropriate to insert into a standard size knock-out opening for an electrical junction box. The outer diameter of the cylindrical wall 14 at the flange end of the bump 34B has an outer diameter exceeding that of a standard size knock-out opening for an electrical junction box. In the present embodiment, the flange end 34B of the bump 34 includes a wall with a surface plane substantially perpendicular to the central axis 18 of the cylindrical wall 114. It will be recognized by one skilled in the art that the shape of the bumps can be of various designs without departing from core concept of its function in the invention.

The bumps 34 are located along the outer side wall 36 of the cylindrical wall 14 such that the distance (d) between the lower surface of the flange 12A and the flange end of the bump 34B is appropriate to accommodate the thickness of a portion of the wall of the electrical junction box that surrounds the knock-out opening (not shown). The flange 12 has an outer diameter exceeding that of a standard size knock-out opening for an electrical junction box. As previously discussed, the cutouts 28 provide a hinge motion of the first pair 30 and second pair 32 of gripping jaws which allow the connector 10 to “snap” into position on an electrical box. Specifically, the lower end of the bump 34A contacts the knock-out opening of the box and is forced inward toward the central axis 18 of the cylindrical wall 14, by the force supplied by the installer, allowing the connector 10 to be placed in the knock-out opening of the box. When an installer fully inserts the connector 10 into a knock-out opening in an electrical junction box (not shown), the flange 12 operates as a stop or seat for the connector 10 and the flange end of the bump 34B secures the connector 10 in the knock-out opening by “locking” the distance (d) between the flange end of the bump 34B and the lower end of the flange 12A of the cylindrical wall 14, within knock-out opening.

An additional embodiment will now be described wherein like features have like reference numbers.

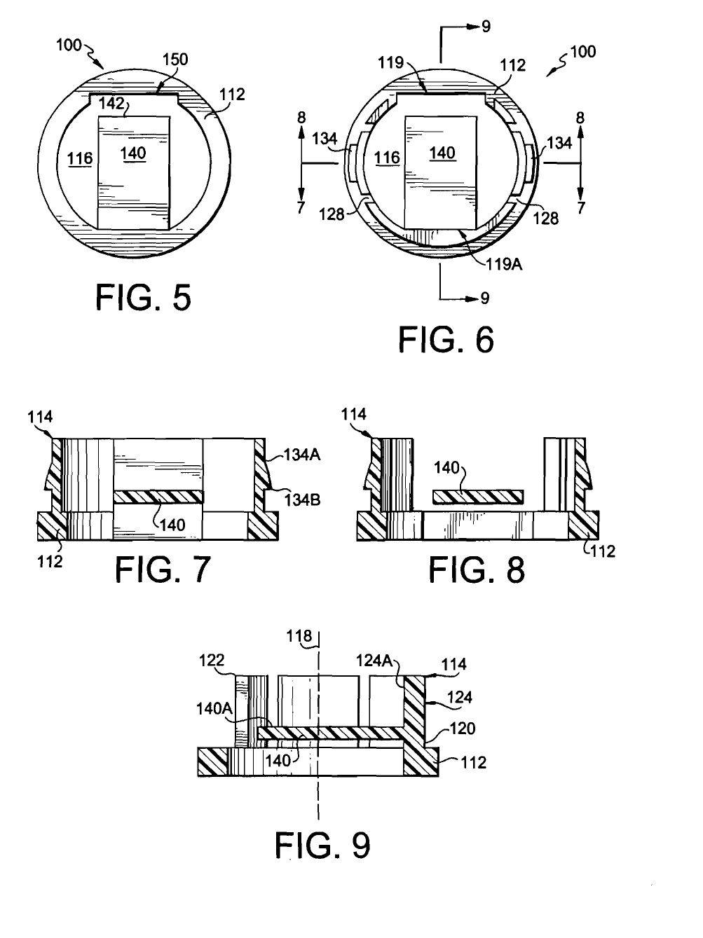

As shown in FIG. 5, another embodiment of the present invention is a one-piece O-shaped connector 110 having a hollow body and fabricated from a flexible, resilient material, such as rubber or plastic. The connector includes a flange 112 and a cylindrical wall 114. The cylindrical wall 114 includes a hollow passageway 116 substantially parallel to its central axis 118. As best illustrated in FIG. 9, the cylindrical wall has a first end 120 attached to the flange 112, a second end 122 (opposite the flange) and a central portion 124. A tab 140 extends from an inner surface 124A of the central portion 124 of the cylindrical wall 114 into the hollow passageway 116 such that a surface plane 140A of the tab 140 is substantially perpendicular to the central axis 118.

As shown in FIG. 6, the cylindrical wall 114 of the connector 110 has an outer diameter appropriate to allow insertion of the cylindrical wall 114 into a standard size knock-out opening for an electrical junction box (not shown). The cylindrical wall 114 includes cutouts 128 that form the side boundary of portions of the cylindrical wall 114 that include bumps 134 for securing the connector 110 in the knock-out opening. As best illustrated in FIGS. 7 and 8, the bumps 134 have a lower wall end 134A proximal to the lower wall 122 and a flange end 134B proximal to the flange 112. The cutouts 128 allow the cylindrical wall portions 114, and the integral bumps 134, to hinge inwardly, and upon clearance of the wall of the electrical box, snap back so as to return to a position perpendicular to the flange 112 and parallel to the central axis 118. This motion and position after clearance of the bump 134 (as discussed in the previous embodiment) “locks” the connector 100 in position on an electrical box. As in the previous embodiment, the bump 134 is an inclined plane or ramp that rises from the lower wall end 112 of the cylindrical wall 114 to the flange end 112 of the cylindrical wall 114 or can be of a convex or concave shape.

As shown in FIGS. 6, 7, 8, and 9, the cylindrical wall 114 extends outward substantially perpendicular to the flange 112. A portion of the cylindrical wall 119 opposite the portion of the cylindrical wall from which the tab extends 11 9A is removed to provide an opening for a cable (not shown) inserted through the connector 100. Referring to FIG. 5, a cutout 150 of the flange 112, located at the position wherein the cylindrical wall is removed 119, compliments the shape of the tab 140 to apply equal contact to a traversing cable (not shown). Specifically, as best illustrated in FIG. 5, the cutout 150 will form a parallel line with an extending end of the tab 142 to establish equal pressure on a traversing cable.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A connector for an electrical junction box comprising:
a. a continuous flange;
b. a cylindrical wall having a first end and a second end, wherein the first end is attached to the flange; and
c. at least one projecting tab extending from the cylindrical wall, wherein the cylindrical wall has a hinge movement at the attachment to the flange.

2. The connector of claim 1, wherein the cylindrical wall has an interior surface and an exterior surface, wherein the interior surface defines a hollow passageway substantially parallel to a central axis of the cylindrical wall.

3. The connector of claim 2, wherein the connector is one-piece and substantially O-shaped, wherein the connector is symmetrical about a midline.

4. The connector of claim 3, wherein the cylindrical wall includes cutouts that form the side boundary of portions of a first pair of gripping jaws and a second pair of gripping jaws.

5. The connector of claim 4, wherein the first pair of gripping jaws and the second pair of gripping jaws extend into the hollow passageway, wherein the first pair and the second pair of gripping jaws each have an extending tooth portion which are substantially perpendicular to the central axis plane of the cylindrical wall.

6. The connector of claim 5, wherein the cylindrical wall has an outer diameter appropriate to allow insertion of the cylindrical wall into a standard size knock-out opening for an electrical junction box.

7. The connector of claim 6, wherein the outer surface of the cylindrical wall comprises at least one bump.

8. The connector of claim 7, wherein the bump has an inclined plane, wherein the inclined plane initiates from a lower wall end of the bump.

9. The connector of claim 8, wherein the outer diameter of the lower wall end of the bump is appropriate to insert it into a standard size knock-out opening of an electrical junction box.

10. The connector of claim 9, wherein the bump includes a wall with a surface plane substantially perpendicular to the surface plane of the cylindrical wall.

11. The connector of claim 10, wherein the flange has an outer diameter exceeding that of a standard size knock-out opening for an electrical junction box.

12. The connector of claim 11, wherein the bump is located along a side of the cylindrical wall such that the distance between a lower surface of the flange and a flange end of the bump is appropriate to accommodate the thickness of a wall of the electrical junction box that surrounds the knock-out opening.

13. The connector of claim 12, wherein the bump has a convex surface.

14. A connector for an electrical junction box comprising:
a. a continuous flange;
b. a cylindrical wall having a first end, a second end and a central portion; and
c. at least one projecting tab extending from the central portion of the cylindrical wall,
wherein the connector is symmetrical about a midline.

15. The connector of claim 14, wherein the connector is a one-piece O-shaped connector forming a hollow body therethrough, wherein the hollow passageway is substantially parallel to a central axis of the cylindrical wall.

16. The connector of claim 15, wherein the connector is fabricated from a flexible, resilient material.

17. The connector of claim 16, wherein the flange extends from a first portion of the cylindrical wall.

18. The connector of claim 17, wherein a projecting tab extending from the central portion of the cylindrical wall into the hollow passageway is substantially perpendicular to a central axis of the cylindrical wall.

19. The connector of claim 18, wherein the cylindrical wall of the connector has an outer diameter appropriate to allow insertion of the cylindrical wall into a standard size knock-out opening for an electrical junction box.

20. The connector of claim 19, wherein the cylindrical wall includes cutouts that form the side boundary of portions of the cylindrical wall.

21. The connector of claim 20, wherein at least two cylindrical wall portions include a bump, wherein the bump is an inclined plane that rises from the second end of the cylindrical wall to the first end of the cylindrical wall.

22. The connector of claim 21, wherein the outer diameter of the cylindrical wall at a flange end of the bump has an outer diameter exceeding that of a standard size knock-out opening for an electrical junction box.

23. The connector of claim 22, wherein the bump is located on the cylindrical wall such that the distance between a lower surface of the flange and the flange end of the bump is appropriate to accommodate the thickness of a wall of the electrical junction box that surrounds the knock-out opening.

24. The connector of claim 23, wherein the flange has an outer diameter exceeding that of a standard size knock-out opening for an electrical junction box.

25. The connector of claim 24, wherein a cutout of the flange compliments the shape of the tab forming a parallel line with an extending end of the tab.

26. The connector of claim 25, wherein a portion of the cylindrical wall is removed opposite the central portion of the cylindrical wall wherein the tab extends.

27. The connector of claim 26, wherein the bump is a convex surface that rises from the second end of the cylindrical wall to the first end of the cylindrical wall.
